(19) United States
(12) Patent Application Publication
(10) Pub. No.: US 2014/0089039 A1
(43) Pub. Date: Mar. 27, 2014

(54) Incident management system

(71) Applicant: Co3 Systems, Inc., Cambridge, MA (US)

(72) Inventor: Chris McClellan, Medford, MA (US)

(73) Assignee: Co3 Systems, Inc., Cambridge, MA (US)

(21) Appl. No.: 14/025,341

(22) Filed: Sep. 12, 2013

Related U.S. Application Data
(60) Provisional application No. 61/699,987, filed on Sep. 12, 2012.

(51) Int. Cl. G06Q 10/06

(52) U.S. Cl. CPC G06Q 10/0635
USPC 705/7.28

(57) ABSTRACT

A method of managing a data breach is implemented in a management platform, preferably as an Internet-accessible service. The method begins upon receipt of data defining a data loss event associated with an organization. The data is processed by a rules engine against a corpus of data sets. A data set is associated with a business requirement (e.g., a State regulation) and encodes a decision tree defining predefined responses prescribed by the business requirement upon occurrence of a data breach. As a result of the processing, a privacy impact assessment defining an impact of the data loss event may be generated. The data loss event may then be escalated into an incident. The incident has associated therewith a response plan that is generated as a function of at least one characteristic of the data loss event and at least one response in the set of predefined responses.

### TECHNICAL FIELD

This disclosure relates generally to managing data loss and, in particular, automating procedures for helping organizations prepare for a data breach or other loss scenario.

### BACKGROUND OF THE RELATED ART

Data loss or breach in an enterprise (e.g., a lost laptop, a cyber-breach, a lost box of records, etc.) can create significant risk, expense and stress on an organization. Indeed, breach management is a complex logistical and administrative concern for many organizations, who struggle to assess when events have occurred, to manage the on-going event, and to manage follow-up reporting to impacted persons and authorities. Assessing potential data loss situations (e.g., an unfolding potential breach or a new third party risk) can require extensive research, such as mapping event characteristics to the complexity of the applicable regulatory environment. As a result, organizations often struggle to quantify the financial or other operational impacts of a potential breach. Significant problems often then arise when a breach or loss actually occurs. Determining whether or not a data breach has occurred and, if necessary, generating an incident response plan, can be complex and also drive substantial professional services fees. Moreover, once an incident response plan has been set, many organizations struggle to manage it, e.g., by using spreadsheets, e-mail, and conference calls. This is incredibly risky, as tasks can easily fall through the cracks, thus further unnecessarily subjecting the organization to fines, lawsuits, and substantial brand damage. Even organizations with sophisticated data loss incident management practices struggle to provide situational awareness on unfolding scenarios, as well as detailed reporting to support management, audit, and regulatory requirements. They lack incident dashboards, and reporting tends to require pulling discrete elements out of e-mail systems, file shares, instant messaging traffic, and the like.

As a result, there remains a need to provide methods and systems to help businesses plan for and assess data breach incidents and develop and manage incident response plans to navigate the maze of compliance and regulatory requirements.

### BRIEF SUMMARY

A method of managing a data breach is implemented in a management platform, preferably as an Internet-accessible service. The method begins upon receipt of data defining a data loss event associated with an organization. The data is processed by a rules engine against a corpus of data sets. A data set is associated with a business requirement (e.g., a State regulation, an industry guideline, a contract clause, other business logic, etc.) and encodes a decision tree defining a set of predefined responses prescribed by the business requirement upon occurrence of a data breach. As a result of the processing, a privacy impact assessment defining an impact of the data loss event may be generated. In response to receipt of a request, the data loss event is then escalated into an incident. The incident has associated therewith a response plan that is generated as a function of at least one characteristic of the data loss event and at least one response in the set of predefined responses.

The foregoing has outlined some of the more pertinent features of the subject matter. These features should be construed to be merely illustrative.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 is a block diagram of service provider infrastructure to support the incident response preparedness platform of this disclosure;

FIG. 2 illustrates the high level functional modules of an incident management platform according to an embodiment;

FIG. 3 illustrates a rule creation logic flow for a particular data loss regulation of interest;

FIG. 4 illustrates rule processing logic flow, which is the basic high-level workflow to process a given incident through the rules that are generated by the process in FIG. 3;

FIG. 5 is a representative rule creation/editing user interface by which a user can select for viewing/editing a particular State regulation;

FIG. 6 illustrates a representative incident response plan or task list resulting from the processing of an incident by the rules engine;

FIG. 7 illustrates a representative display interface by which a user identifies itself to the platform (e.g., by applicable industry, regulators, trade organizations, etc.);

FIG. 8 illustrates a Basic Event Information tab of the event entry wizard by which an administrator defines an event;

FIG. 9 illustrates the first panel of the event entry wizard in more detail;

FIG. 10 illustrates an Additional Event Details tab of the event entry wizard by which an administrator defines further event characteristics and tracking details as such information is obtained;

FIG. 11 illustrates a Data Types tab of the event entry wizard by which an administrator identifies the specific types of data suspect to be lost as a result of the event, as well as the distribution of that data;

FIG. 12 illustrates a representative Impact display (of privacy impact assessments) that is generated by an event analysis executed by the system;

FIG. 13 illustrates an incident response plan that is generated by the management module;

FIG. 14 illustrates how tasks can be assigned to the appropriate team members, progress tracked and attention given to areas that might need it;

FIG. 15 illustrates how an incident response plan may also include rich detail, such as links to the regulations that triggered the task, and custom notification templates that can be used to generate required actions;

FIG. 16 illustrates a dashboard for the interface by which an authorized user can view an overall state of the organization's management efforts; and

FIG. 17 illustrates a sample reporting display interface for the platform by which an authorized user can produce a report.

### DETAILED DESCRIPTION OF AN ILLUSTRATIVE EMBODIMENT

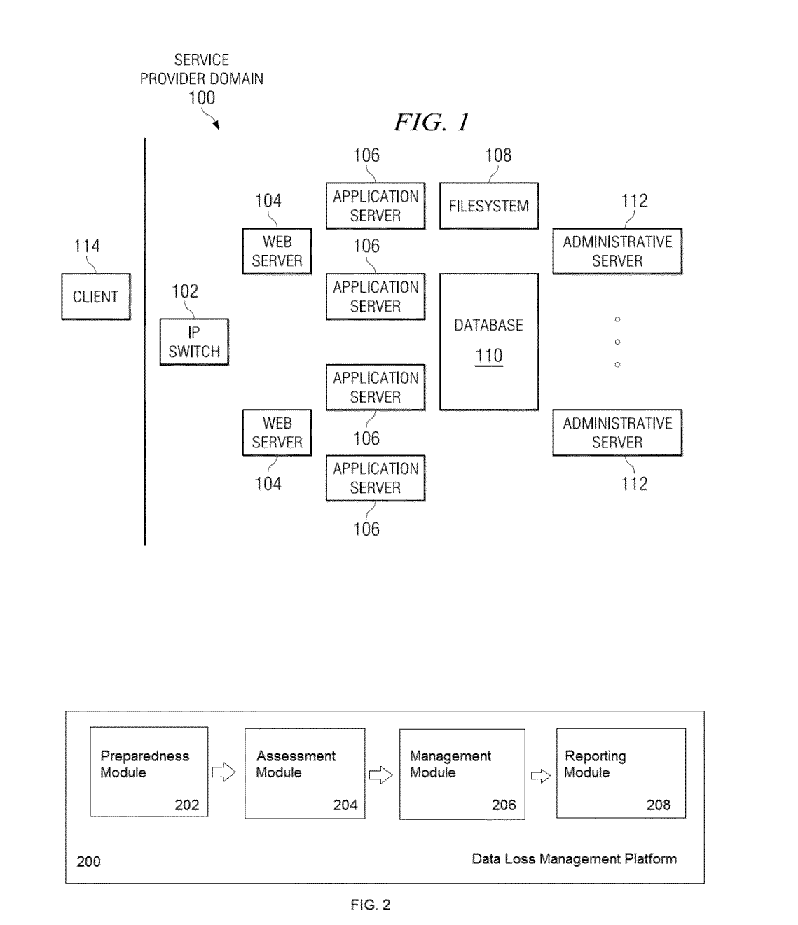

The disclosed techniques described below may be practiced, preferably as a service, in association with a computing infrastructure comprising one or more data processing machines. This type of service (in whole or in part) may be implemented on or in association with a service provider infrastructure 100 such as seen in FIG. 1. A representative infrastructure of this type comprises an IP switch 102, a set of one or more web server machines 104, a set of one more application server machines 106, a database management system 108, and a set of one or more administration server machines 110. Without meant to be limiting, a representative technology platform that implements the service comprises machines, systems, sub-systems, applications, databases, interfaces and other computing and telecommunications resources. A representative web server machine comprises commodity hardware (e.g., Intel-based), an operating system such as Linux, and a web server such as Nginx (with SSL terminator), Apache 2.x (or higher), or the like. A representative application server machine comprises commodity hardware, Linux, and an application server such as Tomcat, WebLogic 9.2 (or later), or others. The database management system may be implemented using PostgreSQL, or a commercially-available (e.g., Oracle (or equivalent)) database management package running on Linux. The web-based front end implements a J2SE (or equivalent) web architecture, with known front-end technologies such as AJAX calls to a RESTful API, Backbone.js jQuery and jQuery UI, HAML templates, and Twitter-based Bootstrap and SASS (for CSS). In one embodiment, an Nginx-based web server is configured to proxy requests to a Tomcat-based application server. Requests are received via HTTPS and sent out over AJP. The application server technologies include, in one embodiment, J2SE applications, a REST interface (e.g., Jersey), JSP-support, and Hibernate using JDBC procedures. The infrastructure also may include a name service, FTP servers, administrative servers, data collection services, management and reporting servers, other backend servers, load balancing appliances, other switches, and the like. Each machine typically comprises sufficient disk and memory, as well as input and output devices. The software environment on each machine includes a Java virtual machine (JVM) if control programs are written in Java. Generally, the web servers handle incoming business entity provisioning requests, and they export a management interface. The application servers manage the basic functions of the service including, without limitation, business logic, as will be described below.

One or more functions of such a technology platform may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, networking technologies, etc., that together provide the functionality of a given system or subsystem. As described, the functionality may be implemented in a standalone machine, or across a distributed set of machines.

As noted above, the front-end of the above-described infrastructure is also representative of a conventional web site (e.g., a set of one or more pages formatted according to a markup language).

Client devices access service provider infrastructure as described to retrieve content, including HTML, media players, video content, and other objects. A typical client device is a personal computer, laptop, mobile device, tablet, or the like. A representative mobile device is an Apple iPad® or iPad2, iPad Mini, an Android™-based smartphone or tablet, a Windows®-based smartphone or tablet, or the like. A device of this type typically comprises a CPU (central processing unit), such as any Intel- or AMD-based chip, computer memory 304, such as RAM, and a flash drive. The device software includes an operating system (e.g., Apple iOS, Google® Android™, or the like), and generic support applications and utilities. The device may also include a graphics processing unit (GPU), and a touch-sensing device or interface configured to receive input from a user's touch. The touch-sensing device typically is a touch screen. The mobile device comprises suitable programming to facilitate gesture-based control, in a manner that is known in the art. The client is not limited to a mobile device, as it may be a conventional desktop, laptop or other Internet-accessible machine running a web browser (e.g., Internet Explorer (6 or higher), FireFox (1.5 or higher), Safari (3 or higher), or the like. Content retrieved to the client may be rendered in a browser, within a mobile app, or other rendering engine.

### Incident Response Planning and Management

The above-described infrastructure may be used to provide an incident management platform and associated data loss/breach incident management service, as are now described.

Effective data loss management preferably is built upon four (4) procedural pillars: prepare, assess, manage and report. To that end, a management platform 200 in FIG. 2 includes four (4) functional modules, namely a preparation module 202, an assessment module 204, a management module 206, and a reporting module 208. These functional modules may be separate or integrated in whole or in part, and they need not be co-located. They execute on the hardware and software infrastructure described above in FIG. 1. The platform may be operated as a “service” on behalf of participating enterprises by a service provider, e.g., at one or more Internet-accessible web domain(s) or sub-domains.

The management platform 200 enables automation of the preparation, assessment, management and reporting procedures, and informing them based on a knowledgebase of laws, regulations and best practices. Using this platform, an enterprise reduces the risk, expense, and stress of data loss events. As will be seen, the preparedness function 202 of the platform improves organization readiness by enabling an enterprise to assign a response team in advance, describe the environment, simulate events and incidents, and focus on organizational gaps. The assessment function 204 enables the organization to quantify potential impact and support privacy impact assessments by tracking events, scoping regulatory requirements, identifying potential monetary exposure, sending notices to impacted personnel, and generating privacy impact assessments (PIAs). The management function 206 enables the organization to generate detailed incident response plans by which the organization can assign tasks to individuals, notify regulators and impacted clients, and monitor progress to completion of remedial actions. The reporting module 208 enables the organization to document incident results and track performance, including calculating costs to close and to generate audit/compliance reports.

As noted above, the platform helps organizations prepare for a data breach through functions that ensure incident response preparedness. Organizations that efficiently weather data loss/breach situations do so because they are prepared in advance. The platform described herein helps organizations prepare for a data breach through a prepare functional module that support running simulations to gauge readiness and highlight areas for improvement, setting policy, and recruiting incident response team members. Using the preparedness module 202 of the platform, organizations can run fire drills or tabletop exercises that drive awareness, train incident response team members, and determine organization preparedness. Organizations can simulate different data loss situations (e.g., a lost laptop, a cyber-breach, a lost box of records, etc.) and practice managing them. Using the platform, the organization can then configure and manage policy for determining which regulations apply and what timeframes to use for notification. The organization can set this policy once and then know that going forward all events and incidents will be treated in the same fashion, in accordance with organization policy.

The assessment functional module 204 enables the organization gauge data breach situations for organization impact. As noted above, assessing potential data loss situations (e.g., an unfolding potential breach or a new third party risk) can require extensive research, mapping event characteristics to the complexity of the applicable regulatory environment. As a result, organizations struggle to quantify the financial or other operational impacts of a potential breach. The platform transforms the assessment process through its ability to log and track events, scope their regulatory requirements, and estimate potential financial liability. For example, an event assessment function automatically maps data loss event characteristics like data type (e.g., credit card number, personal health record, etc.) to the appropriate regulators (PCI-DSS, HIPAA/HITECH, etc.), and the system provides a snapshot, based on the specific event parameters, of the resulting required actions (e.g., notify the State Attorney General) as well as the estimated potential financial liability based on the related fines. The assessment module also enables the organization to simulate risk assessments, e.g., to quantify the risk that proposed initiatives may collect sensitive information, or to model the impact of a potential breach scenario. These features support privacy impact assessments (PIAs) and enable what-if scenario planning in response to a management inquiry or industry news (like a breach at a competitor). As will be seen, the platform enables an organization to assess data breach incidents and develop incident response plans to navigate the maze of compliance and regulatory requirements through the data loss management platform.

The management functional module 206 enables an organization to generate incident response plans and track them to closure. As also noted above, determining whether or not a data breach has occurred and, if necessary, generating an incident response plan, can be complex and also drive substantial professional services fees. Moreover, once a plan has been set, many organizations struggle to manage it, e.g., by using spreadsheets, e-mail, and conference calls. This is incredibly risky, as tasks can easily fall through the cracks, thus unnecessarily subjecting the organization to fines, lawsuits, and substantial brand damage. The platform described herein dramatically streamlines incident management by providing automated incident response plan generation that includes rich regulatory context and project management functions. Using the platform, an organization can manage data loss/breach situations by leveraging its ability to generate detailed incident response plans, and to manage the “who/what/when” of breach response. Tasks in the plan preferably include regulatory requirements in addition to recommended best practices.

The reporting functional module 208 enables the organization to easily document incident response status and effectiveness. As noted, even organizations with sophisticated data loss incident management practices struggle to provide situational awareness on unfolding scenarios, as well as detailed reporting to support management, audit, and regulatory requirements. They lack incident dashboards, and reporting tends to require pulling discrete elements out of e-mail systems, file shares, instant messaging traffic, and the like. The reporting functional module addresses these issues by making it easy to see what new tasks require attention, and to determine the high level status of open events and incidents. The reporting functions show incident response progress, track historical performance, and support organizational audit and compliance requirements. To support detailed audit and regulatory requirements, preferably all activity is time and date-stamped.

As used herein, the following terms shall have the following meanings:

An “event” is the occurrence of a situation that might have the potential of triggering a response managed through the platform.

An “incident” is an event that has been determined to require a response managed through the platform.

A “rule” is a provision comprising one or more conditions and one or more actions. Platform rules typically are of two types: (1) event assessment rules that determine if an event triggers any applicable regulations; and (2) task definition rules that instantiate tasks within an incident management plan.

An “organization” or “enterprise” or “tenant” or “company” is a customer of the service provided by the platform (through, e.g., a service provider).

“Protected Personal Information” (PPI) is information about individuals whose management or disclosure is covered by regulations, contractual provisions or corporate policies managed through the platform. Such information may include, without limitation, social security numbers, credit card numbers, health-related information, and the like.

A “CISO” is a Chief Information Security Officer; typically, this is the company officer with the most direct operational supervision of events and incidents.

In general, the platform is used by CISOs (or those individuals delegated thereby) to help them stay abreast of laws and regulations (e.g., federal, state, trade, and potential others) in the breach management/privacy space, to assess the severity of potential exposures of PPI, and in the case of a “breach” to provide a series of tools that enable the organization to address and manage the incident by meeting all regulatory requirements in a fully-tracked, auditable and reviewable process. To this end, the platform provides a rule database (and associated management system) that reflects various regulations and provisions applicable in case of a privacy breach. The source of a rule can be state law, a federal regulation, a trade association's code of conduct, a contractual provision, a corporate policy, an industry practice, or the like. Preferably, non-company-specific rules (e.g., organized in sets based on source of industry applicability) are generated, maintained and exposed by the platform service provider, and an individual company customer preferably has the ability to add its own rules. The customer-facing functionality of the platform is divided into two tiers: a first tier that provides company/product setup and the evaluation of events; and second tier that provides incident management features. Preferably, and as described above, the platform is accessible via the public Internet, although the functionality may be implemented in a standalone or dedicated product.

The following describes an organization setup and administration to use the service. A permitted individual (e.g., CISO or his/her designee) accesses the service platform and, using one or more web-based interface display forms, provides general organizational data, and sets user administrative privileges. Preferably, the platform supports different levels of access. An organization's administrator can create users and set all related data. An individual user may have access to a limited set of data and preferences for self-service administration. A user privileges model allows for varying degrees of organizational complexity and frequency of use. A typical use case scenario consists of an organizational administrator who is also an incident manager, and a small number of task executors. A much more complex use case scenario is one where there are one or more organization administrators, separate rule management and policy management responsibilities, a set of users with broad read/write access to incident data (e.g., CEO, CFO, Board members), a set of users with broad read access to the system, including logs and historical data (e.g., auditors), incident-level managers, auditors and contributors, task-level managers, auditors and contributors, template incident- and task-level privileges for each user that can be changed for each incident or task instance, groups to facilitate sharing of privileges within organizational compartments, and a mechanism to allow users to cross organizations (e.g., to allow a customer or vendor representative to access an incident). Preferably, the platform is configurable through a number of organization-wide preferences accessible by the organization administrator.

Preferably, the platform service provider maintains a database of rules that are relevant to the domain of breach management. Preferably, rules are organized in rule sets, each corresponding to a specific source. Based on geographic scope of business and industry sector, the organization administrator can determine what specific rule sets are applicable to the organization. Preferably, each organization has the ability to edit the way a system rule is applied within the organization, and to create organization-specific rules based on contractual provisions, corporate policy, and the like. As noted, one or more configuration interfaces (e.g., web-based displays with forms, etc.) may be used for this purpose.

Preferably, the platform provides functionality to manage an organization's breach policy manual, dictating how the organization should respond to a privacy breach. An organization's policy manual preferably is generated by merging one of a number of manual templates with organization-specific data, collected either during the organization setup or during the creation of the manual itself, with the applicable rule sets.

As noted above, an event is an entity representing a potential privacy breach within an organization. An event can be defined within the platform via an event initiation wizard (as described below), which collects data about the event's circumstances and the nature of the data potentially compromised. The latter can also be accomplished by uploading an anonymous version of the actual data, transformed to match a template, or by passing data to the system programmatically, such as over a series of one or more service calls. The event data are run through the applicable rules to determine whether the event triggers the need for a specific response. The data collection and assessment phases can be run one or more times on the same event in case further and better information about the event becomes available.

The following describes an incident initiation process according to an embodiment. Once an event is deemed to require a response (e.g., by an administrator, based on the results of the event assessment), the event data are run against the applicable rules to develop an incident management plan. From that point forward, the term “event” is replaced by the term “incident.” An incident initiator then assigns users to the incident, and preferably one user is given the role of incident manager (IM). Preferably, the IM reviews the incident management plan, creates one or more non-rule tasks as necessary, assigns one or more resources to each task, reviews user privileges, and finally approves the plan. Upon plan approval, users are notified of task assignment and system tasks are executed. The incident initiation process, and specifically the creation of the plan from rules, can be executed repeatedly as more and better information becomes available. A web-based interface tool may be used to facilitate these configuration and management actions.

The platform preferably provides an incident management process. Preferably, the platform includes or interfaces a project management system to handle tasks. Using an interface, the IM can create and edit tasks, and assign responsibility for them. The user responsible for a task (task manager—TM) can edit task data and determine task completion. Other users collaborating on a task preferably have limited task-editing capabilities. Tasks can be dependent upon each other (end-to-start). A task can have multiple dependent tasks, activated based on outcome. Tasks can be assigned to a group to share responsibility and visibility of the task among that group's users. When a task becomes overdue, preferably the IM (or other user determined according to an escalation path) is notified.

The platform preferably provides a dashboard and reporting functionality to facilitate management of the incident management plan. Preferably, each user has access to a dashboard showing a status of all items (tasks and/or incidents) for which the user has a direct responsibility. Preferably, each item or grouping of items in the dashboard shows a summary health indicator (e.g., green, yellow or red) based on the state of completion versus due data of each relevant item. Each user can receive periodic reports on the status of items of interest. Users also get notifications whenever an item of interest is yellow or red. Preferably, the platform enables users to add threaded comments to incidents and tasks, and the incident or task manager may moderate the comments. Preferably, organizations, incidents and tasks have associated document repositories. Preferably, a user with auditing privileges can see all events (create, edit and view) associated to a given entity including user and originating IP address. An auditor can also see what an entity looked like at any given point in the past.

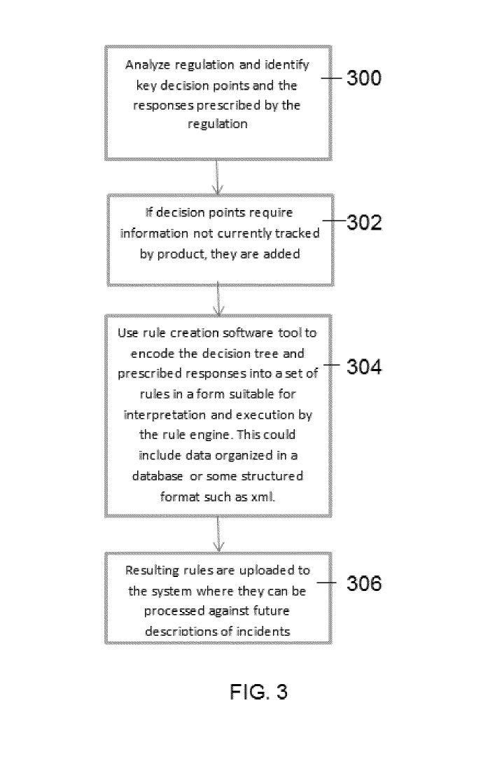

FIG. 3 illustrates rule creation logic, which is the basic high-level workflow for the process of converting a particular State regulation into a set of one or more rules. The routine begins at step 300 with an analysis of an applicable regulation. This analysis may be performed by legal counsel or some other authorized person (or information about the regulation may be obtained from an external source, automatically, programmatically, or otherwise). The analysis breaks down the regulation into one or more key decision points and the responses prescribed by the regulation. If decision points require information not currently tracked, they are added into the rule creation logic flow at step 302. At step 304, a rule creation software tool is used to encode the decision tree and prescribed responses into a set of rules, preferably in a form that is suitable for interpretation by a rules engine of the system. The associated data used by the decision tree may be organized in a database or otherwise supported in a structured format, such as XML. At step 306, the resulting rules are then uploaded to the system where they can be processed against future descriptions of events.

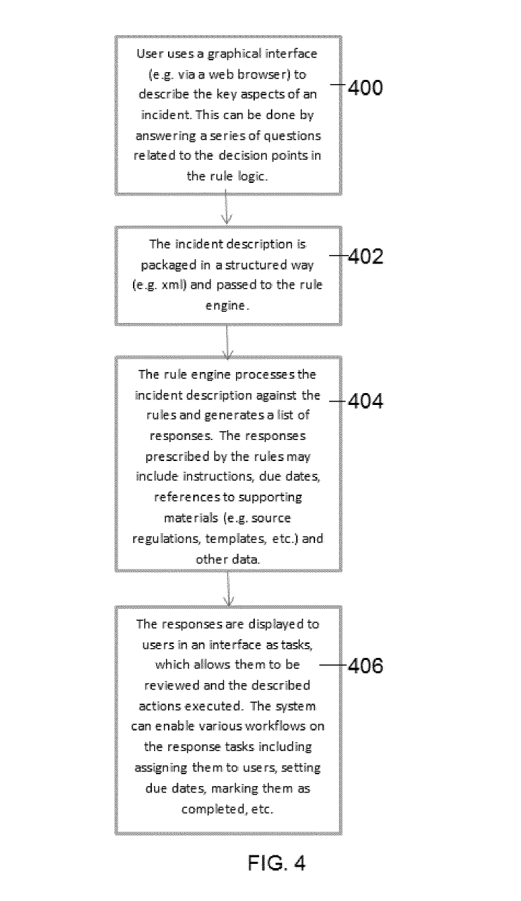

FIG. 4 illustrates rule processing logic flow, which is the basic high-level workflow to process a given incident through the rules that are generated by the process in FIG. 3. The routine begins at step 400 with the user using a graphical user interface (e.g., via a web browser) to describe the key aspects of an event (that may end up being classified as an incident). This can be done by the user answering a series of questions related to the decision points in the rules logic. In an alternative embodiment, the data representing the event may be passed into the system (in whole or in part) in an automated or programmatic manner. At step 402, the incident description is packaged in some structured way (e.g., XML) and passed to the rules engine. At step 404, the rules engine processes the incident description against all rules and generates a list of responses. The responses prescribed by the rules can include instructions, due dates, references to supporting materials (e.g., source regulations, templates, etc.) and other data. At step 406, the responses can then be displayed to users in an interface as a set of tasks, which can then be reviewed and the described actions executed. The system can enable various workflows on the response tasks including, without limitation, assigning them to users, setting due dates, marking completion dates, and so forth.

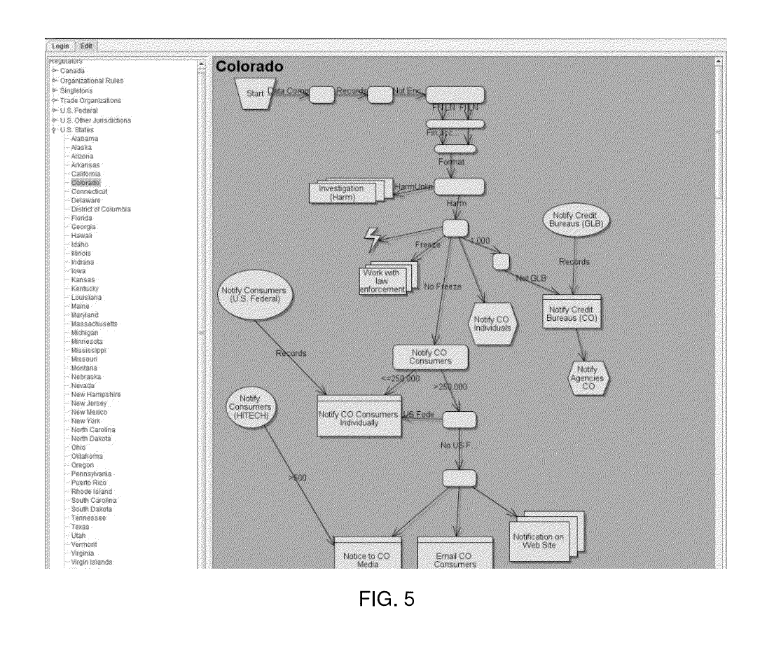

FIG. 5 is a representative rule creation/editing user interface by which a user can select for viewing/editing a particular State regulation (in this example, for the State of Colorado).

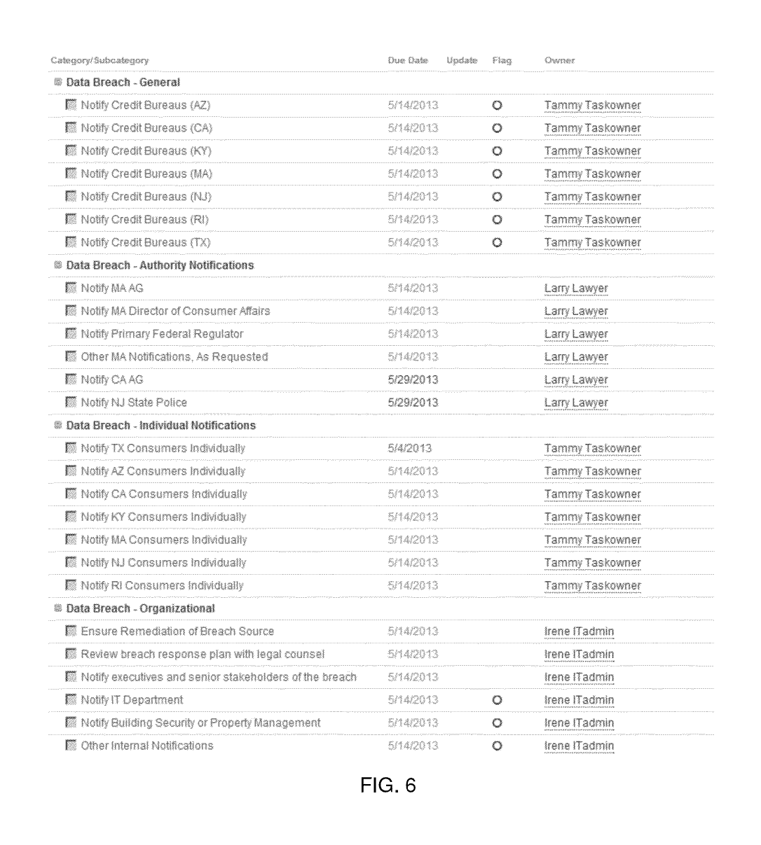

FIG. 6 illustrates a representative incident response plan or task list resulting from the processing of an incident by the rules engine. This plan identifies the various organizations that are to be notified, a notification deadline, and a responsible individual.

Thus, according to this disclosure, each of a set of regulations of interest is mapped from a decision tree into a set of rules (a rule set) against which a description (of a data breach/loss event) is processed. If the description (itself a set of data) matches against the rule set (or any other rule set in a rule corpus), the system affords the user an opportunity to generate a customized incident response plan or task list identifying prescribed actions that should be taken (based on criteria in the rules) to address the data breach/loss event. A particular data breach event may trigger multiple rules in multiple rule sets (e.g., from more than one State, a State and a contract, etc.), and the resulting incident response plan may include remedial activities to address all required notification and reporting requirements. Or, multiple incident response plans may be generated.

The rules engine may be implemented as software, namely, one or more computer programs executed by one or more data processors (hardware elements). The particular functions of the rules engine is to receive the data indicative of the data breach/loss event, retrieve the rule corpus, compare the breach data against the rule set to identify a match, and, upon a match, to generate an incident response plan. The system then tracks the incident response plan as one or more remedial actions is taken.

The following provides additional description regarding a display interface to facilitate user interaction with the platform through the preparation, assessment, management, and reporting modules described above with respect to FIG. 2.

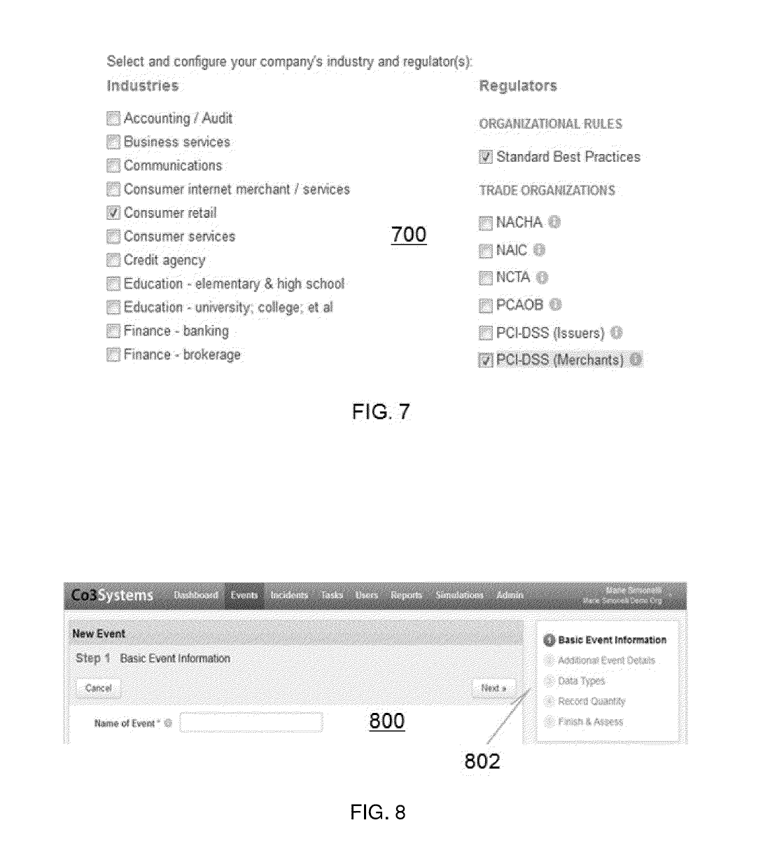

FIG. 7 illustrates a representative display interface 700 by which a user configures the platform for their particular circumstance (e.g., by applicable industry, regulators, trade organizations, etc.). Using the data entered into the interface panel 700, the system determines what regulations may apply to a potential data loss, and to build a potential incident management plan accordingly.

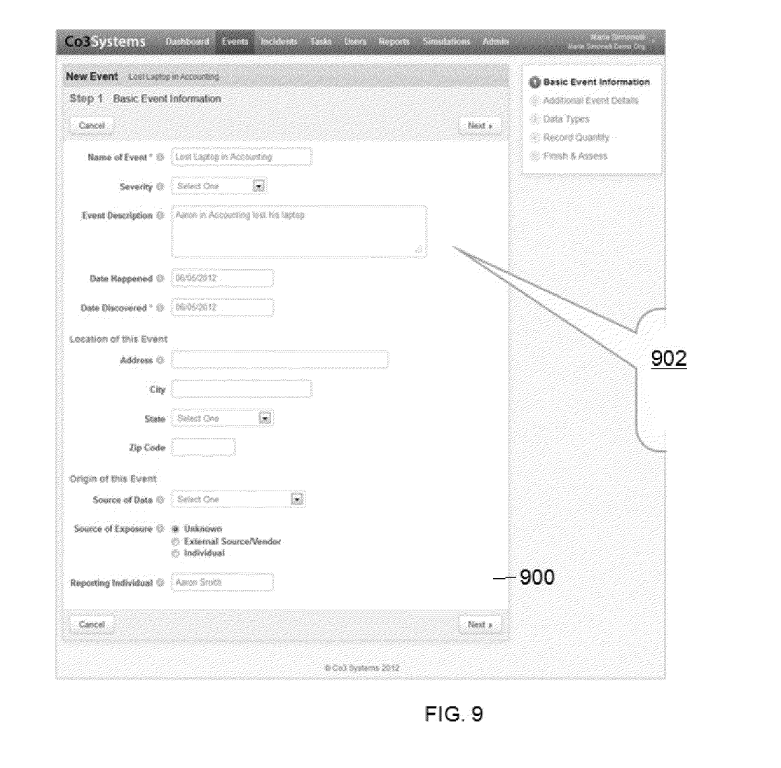

FIG. 8 illustrates a Basic Event Information tab 800 of the event entry wizard by which an administrator defines an event. Preferably, a multi-step entry process 802 is used. FIG. 9 illustrates the first panel of the event entry wizard 900 in more detail. As can be seen, in this embodiment, an event is defined by one or more data fields 902: name, severity, description 902, date happened, date discovered, location, origin, source of data, source of exposure, and reporting individual. These fields capture what happened, when, who reported it, and so forth.

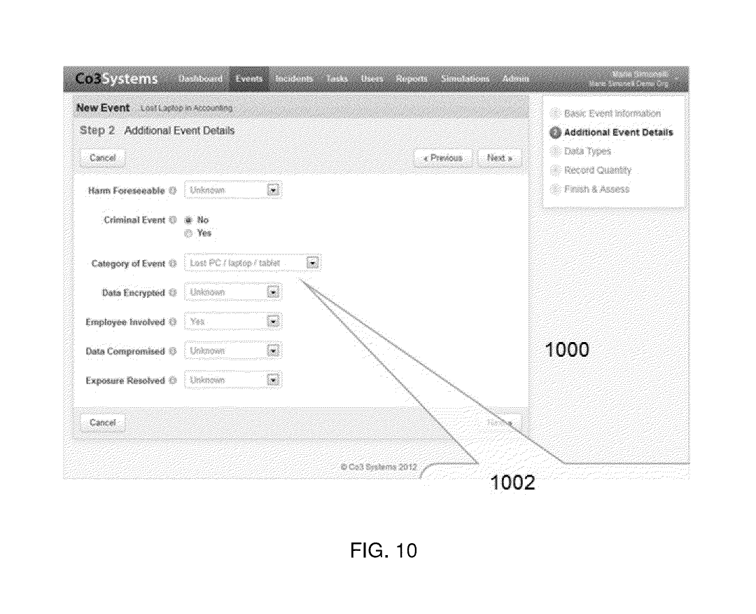

FIG. 10 illustrates an Additional Event Details tab 1000 of the event entry wizard by which an administrator defines further event characteristics and tracking details as such information is obtained. This information 1002 includes, for example, harm foreseeable, whether the event involves a crime, the category of the event, whether encrypted data is involved, whether an employee is involved, whether data is compromised, and whether the exposure is resolved.

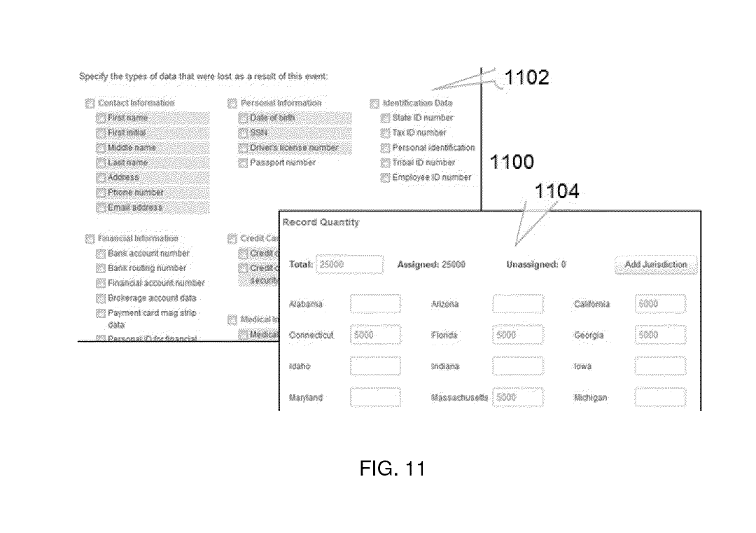

FIG. 11 illustrates a Data Types tab 1100 of the event entry wizard by which an administrator identifies the specific types of data 1102 suspect to be lost as a result of the event, as well as the distribution 1104 of that data (preferably in total, and by selected locale).

FIGS. 8-11 are display screens associated with the assessment module.

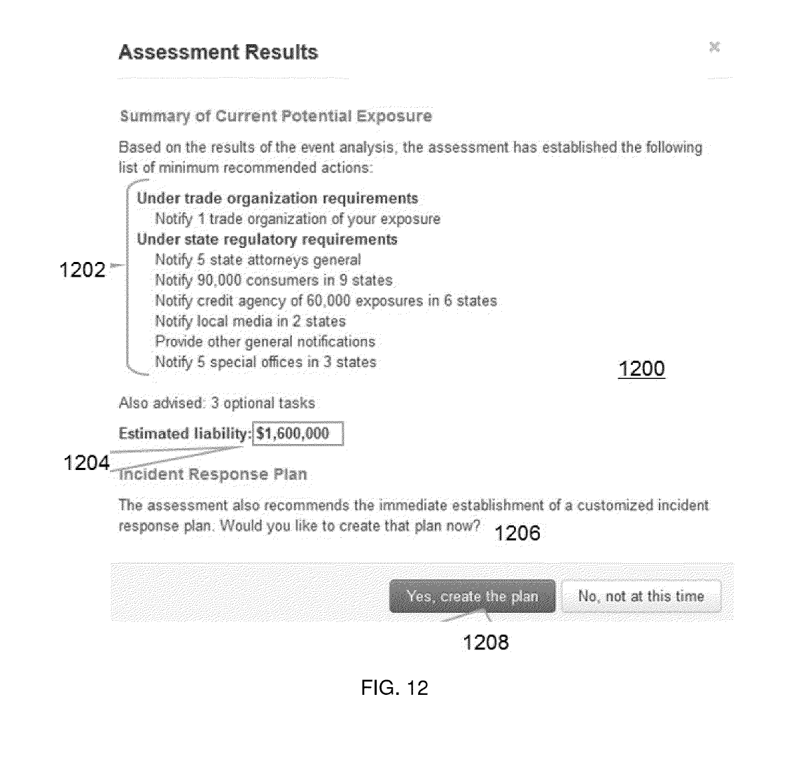

FIG. 12 illustrates a representative Impact display (of privacy impact assessments) that is generated by an event analysis executed by the system, namely, processing by the rules engine of event data (such as entered in display screens in FIGS. 8-11) against the rules in the rules corpus. An assessment allows the user to gauge the impact of a potential or actual event, typically so that the user can determine whether to escalate the event to an incident. To this end, the Assessment Results 1200 panel typically comprises several fields, a minimum set of tasks (recommended actions) 1202 that should be performed (typically notifications of identified entities), an estimate 1204 of potential exposure (e.g., an aggregate monetary fine), and a textual (or other style) query 1206 to determine whether the user desires to generate a customized incident response plan. By selecting a “Yes” button 1208, the system then generates the incident response plan, namely, a list of tasks defining what/when/who/how the incident will be addressed.

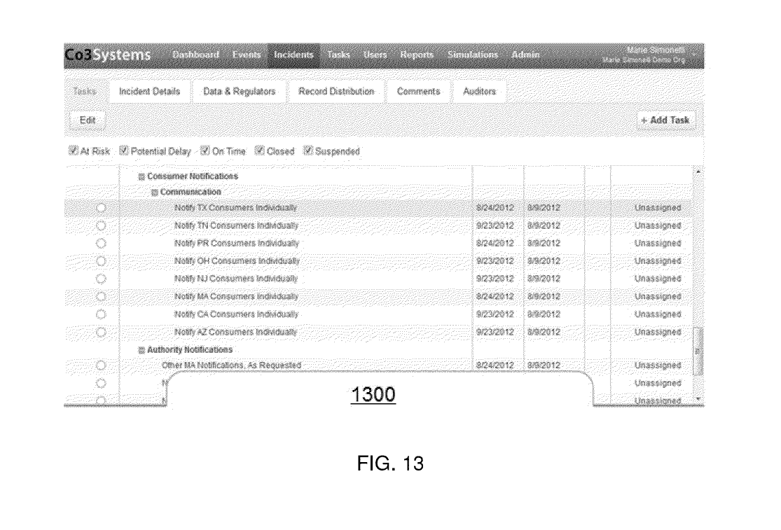

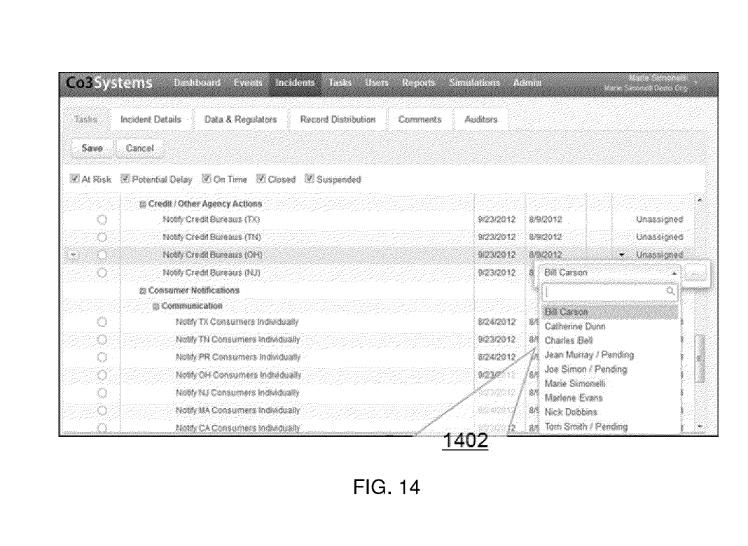

FIG. 13 illustrates an incident response plan 1300, which is generated by the management module. An example of such plan is also seen in FIG. 6. The plan identifies the various notifications (e.g., consumer notifications, authority notifications, etc.), the timing of such notifications, and the individual assigned to the task. FIG. 14 illustrates how tasks can be assigned to the appropriate team members (using dropdown list 1402), progress tracked and attention given to areas that might need it.

As can be seen, the escalation (from the event) to the incident thus generates a detailed response plan based on the specifics of the data loss and the one or more regulations that apply to the organization.

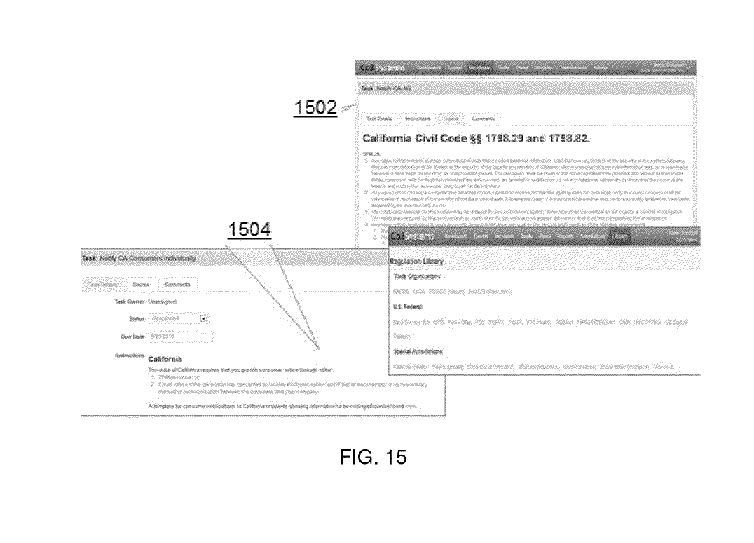

FIG. 15 illustrates how tasks of an incident response plan may also include rich detail, such as links 1502 to the regulations that triggered the task, and custom notification templates 1504 that can be used to generate required actions.

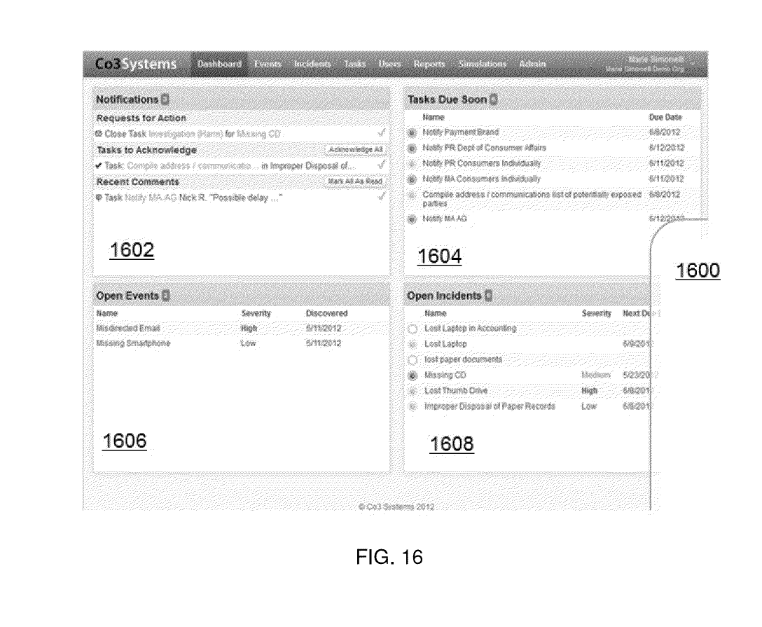

FIG. 16 illustrates a dashboard 1600 for the interface by which an authorized user can view an overall state of the organization's management efforts. The dashboard identifiers the required notifications 1602, the tasks due soon 1604, open events 1606, and open incidents 1608. Using the dashboard, the organization can meet all of its deadlines so as to avoid any notification failures (and thus any associated fines), easily see what items need attention, and track and report the status of events and incidents.

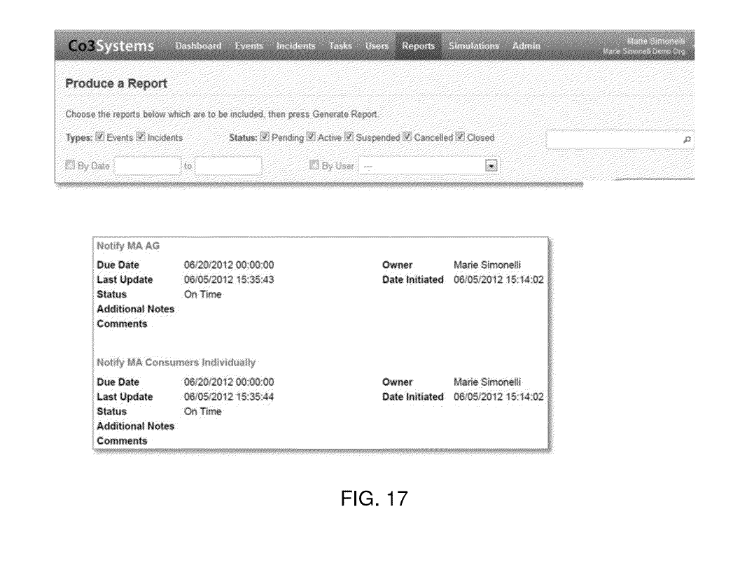

FIG. 17 illustrates a sample reporting display interface for the platform by which an authorized user can produce a report. Preferably, every event is tracked in detail and time and date-stamped. A report is comprehensive and documents what has happened over time, thus providing a rich source of audit details for regulators and auditors. The output of the report may be customized as needed.

The display screens illustrated are a representative GUI for the management platform but are not intended to be limiting. Other display or output formatting may be used, depending on the hardware and software details of the particular implementation.

While the privacy impact assessment is shown as being displayed prior to display of the incident response plan, this is not a requirement, as the system may generate the incident response plan automatically without the user selecting to view it. In such case, the incident response plan may include or link to the privacy impact assessment.

While the techniques herein describe the rule creation logic flow (FIG. 3) in the context of a data breach/loss regulation (such as a State law), as noted above the technique may also be used to generate a rule set from a business rule, a contract provision, an industry guideline or practice, or the like. More generally, any set of conditions may form an input to the rule creation logic to generate a rule set against which the data breach/loss event data may then be processed (by the rules engines).

While the above description sets forth a particular order of operations performed by certain embodiments, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computing entity selectively activated or reconfigured by a stored computer program stored. Such a computer program may be stored in a computer readable storage medium, such as, but is not limited to, any type of disk including an optical disk, a CD-ROM, and a magnetic-optical disk, flash memory, a read-only memory (ROM), a random access memory (RAM), a magnetic or optical card, or any type of non-transitory media suitable for storing electronic instructions.

While given components of the system have been described separately, one of ordinary skill will appreciate that some of the functions may be combined or shared in given instructions, program sequences, code portions, and the like.

Having described my invention, what I now claim is as follows.

1. A method of managing a data breach, comprising:
receiving data defining a data loss event associated with an organization;
processing, using a rules engine executing in a hardware element, the data against a corpus of data sets, wherein a data set is associated with a business requirement and encodes a decision tree defining a set of predefined responses that are prescribed by the business requirement upon occurrence of a data breach;
as a result of the processing, escalating the data loss event into an incident, the incident having associated therewith a response plan that is generated as a function of at least one characteristic of the data loss event and at least one response in the set of predefined responses.

2. The method as described in claim 1 further including:
outputting a privacy impact assessment that defines an impact of the data loss event; and
responsive to receipt of a request associated with the privacy impact assessment, performing the escalation of the data loss event in the incident.

3. The method as described in claim 1 further including displaying the response plan as a set of one or more tasks.

4. The method as described in claim 3 wherein the set of one or more tasks identifies a notification requirement, a task deadline, and an individual assigned to complete the notification requirement by the task deadline.

5. The method as described in claim 4 further including tracking compliance with the one or more tasks.

6. The method as described in claim 1 wherein the business requirement is one of: a state, federal or local regulation, law or ordinance, an industry guideline, a contract provision, a business rule, and a custom or trade practice.

7. The method as described in claim 1 wherein the data defining the data loss event is received in a structured data format.

8. The method as described in claim 1 wherein the data defining the data loss event includes a type of data suspected to be compromised and residency of one or more individuals impacted by the data breach.

9. An apparatus, comprising:
a network-accessible infrastructure operating at a service provider domain, the network-accessible infrastructure comprising at least one web server providing to each of a set of participating users a web page in which is received data describing a data loss event;
a service application instance executing in the network-accessible infrastructure to process, using a rules engine, the data against a corpus of data sets, wherein a data set is associated with a business requirement and encodes a decision tree defining a set of predefined responses that are prescribed by the business requirement upon occurrence of a data breach;
the service application, as a result of the processing, escalating the data loss event into an incident, the incident having associated therewith a response plan that is generated by the service application as a function of at least one characteristic of the data loss event and at least one response in the set of predefined responses.

10. The apparatus as described in claim 9, wherein the web server displays a privacy impact assessment that defines an impact of the data loss event; and
the service application is responsive to receipt of a request associated with the privacy impact assessment for performing the escalation of the data loss event into the incident.

11. The apparatus as described in claim 9 wherein the web server displays the response plan as a set of one or more tasks.

12. The apparatus as described in claim 11 wherein the set of one or more tasks identifies a notification requirement, a task deadline, and an individual assigned to complete the notification requirement by the task deadline.

13. The apparatus as described in claim 12 wherein the service application tracks compliance with the one or more tasks.

14. The apparatus as described in claim 9 wherein the business requirement is one of: a state, federal or local regulation, law or ordinance, an industry guideline, a contract provision, a business rule, and a custom or trade practice.

15. The apparatus as described in claim 9 wherein the data defining the data loss event is received in a structured data format.

16. The apparatus as described in claim 9 wherein the data defining the data loss event includes a type of data suspected to be compromised and residency of one or more individuals impacted by the data breach.
